(19) United States
(12) Patent Application Publication
(10) Pub. No.: US 2017/0260415 A1
(43) Pub. Date: Sep. 14, 2017

(54) METALLIC COATING COMPOSITIONS

(71) Applicant: DecoArt, Inc., Stanford, KY (US)

(72) Inventor: Yue Man Tang, Lexington, KY (US)

(73) Assignee: DecoArt, Inc., Stanford, KY (US)

(21) Appl. No.: 15/454,439

(22) Filed: Mar. 9, 2017

Related U.S. Application Data
(60) Provisional application No. 62/305,657, filed on Mar. 9, 2016.

(51) Int. Cl. C09D 133/00; B05D 1/28; B05D 5/06; B05D 3/04; C09D 7/12; B05D 7/00

(52) U.S. Cl. CPC C09D 133/00; C09D 7/125; B05D 7/544; B05D 5/06; B05D 3/0406; B05D 1/28; C08K 3/0033

(57) ABSTRACT

A pigment-containing coating formulation combines (i) polymeric wetting and dispersing additives that absorb onto pigment particles to surround pigment particles to prevent or limit sedimentation; (ii) a self-crosslinking acrylic dispersion with low surfactants and long open time, allowing the pigment to lay flat instead of migrating and agglomerating at the surface; and (3) rheology modification facilitating good Newtonian flow behavior and balanced thixotropic thickening of the coating for improved brushability, flow and leveling for improved appearance with keener light reflection and more uniform pearlescent and metallic effect appearance.

### CROSS REFERENCE TO RELATED U.S. APPLICATION

This patent application claims the benefit of priority to U.S. Provisional Patent Application Ser. No. 62/305,657, with a filing date of Mar. 9, 2016, the contents of which are incorporated herein by reference.

### FIELD OF INVENTION

The pertinent field relates to coatings that incorporate pigments that interact with a novel combination of resin, dispersant, rheology, and other additives to achieve improved characteristics, including appearance, brushability, and leveling.

### BACKGROUND

Pigments are small particles of matter that are practically insoluble in a carrier medium, which impart coloring when applied to an article or substrate. Metal pigments are those which contain at least one metal atom, which can be metals or metal alloys. Inorganic metallic pigments include iron oxides, chrome oxides, various chromate pigments, and metal pearlescent pigments, including without limitation potassium aluminum silicate-based pearlescent pigments (also known as “Mica” or “pearlescent Mica”), which may be coated with titanium dioxide, or iron oxide, or both to achieve a metallic look. Examples of organic metal pigments include copper phthalocyanine, with a central copper atom, and sulfur-containing sodium aluminum silicates such as ultramarine blue pigment.

Metal pigments have been used to provide color to coatings for some time. Some who use these coatings desire a shimmering appearance and reflectiveness—approximating that of a chrome or other metal surface—that the metal pigments impart. As used herein, “metallic” refers to appearance in that the pigment provides a reflective, metallic appearance. Pearlescent Mica is one such pigment that offers a metallic appearance favored by many consumers. Studies, such as by light microscopy or scanning electron microscopy, have shown that these desirable properties are enhanced as the metal particles are placed in more uniform alignment to each other with their alignment. Stated differently, if the alignment of the metallic pigment particles is very random as the coating is applied, and as it dries, the appearance seems less like a reflection and the benefits of using metallic pigments are reduced.

Brushing is the customary way of applying coatings that contain metallic pigments. Problematically, when brushing a coating onto an article or a substrate, it generally leads to random alignment of all the particles contained in the coating, including in this instance the metallic pigments. The problem is compounded due to the fact that a user may impart many brush strokes on a surface in order to obtain even coverage with the coating. Other methods of applying a coating, such as spraying, have drawbacks as well. Improvement is needed with respect to particle alignment with respect to coatings that use metallic pigments.

Several approaches have already been tried with respect to improving the appearance of coating in general, and metallic coatings in particular. One approach involves the attempt to achieve an appearance similar to that of a solvent- or oil-based coating with a water-based system. This would be desirable because solvent-based systems become thinner after being applied as the solvent evaporates. Consequently, the film is thinner by comparison, and the pigment particles show up flatter. Conversely, maintaining thickness, as with a water-based system that does not evaporate, makes the pigment stand out more prominently. It makes the appearance sharper, without appearing cloudy or hazy even when viewed from various angles.

Some approaches have focused on particular modifiers or additives to achieve a balance between thioxotropic thickening of the coating in response to shear, on one hand, and maintaining favorable and Newtonian flow, on the other. Likewise, some approaches have sought to keep the pigment particles suspended longer, so they are available to reflect the light. But in doing so, it increases the propensity of the pigment particles to agglomerate and come together, which reduces the reflectiveness that they would otherwise demonstrate if kept apart. Accordingly, a balance between proper particle alignment and keeping the individual particles separated to a sufficient extent has proven elusive under prior approaches.

Accordingly, it is an objective of the present disclosure to achieve a higher degree of uniformity in the alignment of brush-on coatings that contain metallic pigments, including those which are water-based. It is a further objective to impart a more desirable, enhanced reflective, shimmering appearance of these coatings through this higher degree of uniformity. There is a level of subjectivity regarding this enhancement, which in some respects is in the eye of the beholder. While the level of perceived reflectivity does not always lend itself to a measurement, the practice of these present embodiments will result in a higher degree of uniform alignment of metal particles than previously known systems. This higher degree of uniformity will exist as the metallic pigment particles line up in a more uniform alignment as a coat is brushed on a surface. Likewise, the particles will continue to align more uniformly as the particles contained in additional coats are stacked upon each other.

### SUMMARY OF EMBODIMENTS AND ADVANTAGES

The coatings and formulations disclosed here according to present embodiments utilize a combination of additives, solvent blends, and rheology modifiers working in concert with one or more base resins to provide the advantages discussed in the previous section. The coatings are useful on a variety of surfaces, including metal, plastic, wood, masonry, terra cotta, concrete, decorating paper, and leather, among others. Additives are selected and incorporated in the formulation at a weight percentage conducive to good wetting and dispersing properties, and which resists sedimentation of the metallic pigment particles. One or more solvents are selected and incorporated to impart brushability and limit agglomeration. Additionally, rheology modifiers are selected, combined, and incorporated to enhance brushability and flow leveling, and to promote a substantially uniform alignment of the metallic pigment particles. In addition, the resin selected and incorporated into the composition plays the role of making the pigment particles lay flatter against the surface to facilitate their alignment in a more substantially uniform direction. The result is a metallic pigment-containing coating with very good flow and leveling properties. Following application to a surface, as well as upon drying, the metallic pigment particles are uniformly aligned relative to one another, in a way that increases the reflective appearance that makes these pigments desirable.

Brushing a coating onto a surface generally increases the randomness of how individual particles and constituents in the coating align toward one another. By contrast, the present embodiments provide coatings, as well as methods, that result in highly uniform alignment that promotes the reflective appearance that the metallic pigment particles are intended to foster. By aligning the pigment particles, less loss of light occurs, thus improving the paint's reflectivity.

The subject coatings are easy to apply, and they durably improve the appearance of the article after the coating has dried. Methods of forming such coatings are also described, again in non-limiting fashion, including the type of constituents, the order in which they can be mixed and how they can be mixed. Additional features and benefits will be evident from the detailed description, including discussion of a non-limiting, illustrative embodiment, as set forth in the next section.

### DESCRIPTION OF MULTIPLE EMBODIMENTS AND ALTERNATIVES

The subject embodiments result in coating compositions with excellent aesthetic appearance when applied over various surfaces as selected by a user. Example uses include various art, craft, and home decor uses, to name a few. It is intended that such coatings will be applied to a surface when wet, and allowed to dry. Drying can be done in conventional ways, including exposure to ambient air and exposure to heat. Brushing the coating onto the surface is the preferred way to apply it.

The subject coatings include a resin system, metallic pigment(s), solvents, dispersants, additives, and rheology modifiers. Methods of forming the coatings according to present embodiments include mixing together a resin system, metallic pigment(s), solvents, dispersants, additives, and rheology modifiers in a manner according to known methods. The solvents, pigments, and several of the additives are known and commonly used in coatings of the type contemplated herein. In some embodiments, the methods herein include applying the inventive coatings to the surface of a substrate, which when dried provides an improved uniformity of particle alignment that may be associated with better aesthetic appearance. While particular names of products are provided in an example coating composition, the embodiments are not limited to particular trade names, and reasonable substitutes would also be within the scope of embodiments according to the descriptions and teachings provided herein. As stated above, the benefits of metallic pigments include the reflective, shimmering look they impart on a surface. The more the metallic pigment particles are in uniform alignment, the more this look is enhanced. Alignment here refers both to particles within a particular layer being aligned together (intra-layer) and particles from one coat to the next being aligned (interlayer alignment). Apart from the approaches described here, brushing necessarily has a tendency to interfere with particle alignment. However, the combination of constituents provided in the subject embodiments, and the method of forming the subject coatings described here, causes the metallic pigment particles to lay flat and in substantially more uniform alignment than with prior compositions.

In certain embodiments, the coating compositions, as well as methods of forming them, entail a resin system, which employs a resin, or multiple resins in combination, to impart hardness, scratch resistance and water resistance. Suitable examples include Alberdingk® AC 2300, a self-crosslinking acrylic resin (Alberdingk Boley®, Inc., Greensboro, N.C.); Alberdingk® AC 2320; EPS® 2574 acrylic emulsion (Engineered Polymer Solutions, Marengo, Ill.); and Aquaslip® 656 (Lubrizol® Corporation, Wickliffe, Ohio). The latter is a fine particle size wax emulsion providing good slip properties for the pigment particles to become well aligned and evenly distributed, improving gloss retention and overall brushability.

In some embodiments, at least one resin making up the resin system of the inventive coatings comprises a self-crosslinking acrylic dispersion, with very little surfactant, and demonstrating long open time. The long open time provides opportunity for pigment particles to align well before the drying process fixes them in place, while preventing or limiting these particles from migrating or otherwise agglomerating near the substrate.

Preferably, such one or more resins are solvent-borne acrylic resins having low VOC, with viscosity in a range of about 20-200 mPas, with about 7.0-9.0 is a suitable pH range. In addition to normal resin function of providing a polymeric backbone for the cured coating, the resin(s) in combination with rheology modifiers and other constituents as disclosed here will make the metallic pigment particles lie flat against the surface in a relatively uniform alignment. In some embodiments, a coalescing agent such as Eastman Optifilm® enhancer 400 is included in the compositions for favorable flexibility and adhesion. In some embodiments, the range for such a coalescent agent is about 1.0%-1.5%.

The resins mentioned above are commercially available, and they are used in the formulation of coatings and other applications. But in addition to these constituents, proper wetting, dispersal, and rheology modification are required. For example, much of the reflectiveness and the attendant shimmering appearance is lost when particles do not align well, because the wavelengths of light are trapped between particles and unable to reflect off the surface of the particles as intended. Conversely, when coatings of the present embodiments are used, and the metallic pigment particles are substantially aligned uniformly, significantly more light is reflected off the surfaces of well aligned particles, which preserves the shimmering appearance that is desirable. The present embodiments overcome the challenges associated with obtaining uniform alignment of the metallic pigment particles, even when they are brushed onto a surface.

The success of the present embodiments lies in how the metallic pigment particles line up when the coating is brushed onto a surface. When one coat is dry, a second coat may be applied on top of the first. The particles align themselves within a particular layer (intra-layer), and inter-layer. The first coat and the second coat do not migrate into each other. Reflectivity is enhanced because particles of one coat align themselves with particles of the prior coat.

In the following non-limiting example composition, a plurality of Gold Mica Pearl pigment pigments is utilized. Other pigments may be substituted. A listing of constituents and the weight percentages for this Example coating follows:

### Example—Metallic Pigment-Containing Coating Composition

| Step | Constituents | Wt % |
|---|---|---|
| MIX AT LEAST | Water | 18.08 |
| 5 MIN,: | methyl ethyl hydroxyethyl cellulose | .18 |
| ADD AND MIX WELL: | dimethylethanolamine (DMEA) | .08 |
| | 1,2-Benzisothiazol-3(2H)-one | .16 |
| | BYK ® 024 | .18 |
| | BYK ® 022 | .18 |
| | Agitan ® 786 | .10 |
| | alkyl polyglycol ether phosphate ester | 1.27 |
| | PAT-ADD DA 603 | .90 |
| | 1,2-Propanediol | 7.53 |
| | tripropylene glycol monomethyl ether | 1.59 |
| | diethylene glycol monobutyl ether | 2.81 |
| | 2,2,4-trimethyl-1,3-pentanediol | 1.59 |
| | monoisobutyrate | |
| | Acrysol ASE-60 | .08 |
| ADD PIGMENTS: | Gold Mica Pearl pigment | 12.04 |
| ADD, AND DISPERSE | Alberdingk ® AC 2300 | 22.49 |
| AT HIGH SPEED, | Alberding ® AC 2320 | 16.96 |
| 20 MINUTES: | EPS ® 2574 | 6.36 |
| | Aquaslip ® 656 | 2.39 |
| ADD SLOWLY, WITH | Soygreen 1000E Emulsion | .90 |
| AGITATION: | Optifilm ® 400 | 1.35 |
| | METOLAT ® 750 | .13 |
| | METOLAT ® 780 | .13 |
| | TROYSOL LAC | .40 |
| | oxirane, methyl-,mono(3,5,5- | .27 |
| | trimethylhexyl ether) | |
| | 30% Dow Corning ® 51 Additive | .58 |
| MIX FOR FIVE | Rheotech ® 2800 | .74 |
| MINUTES, ADD: | pentanoic acid, 5-(dimethylamino)-2- | .32 |
| | methyl-5-oxo-,methyl ester | |
| | Polyurethane associative thickener | .21 |
| | Total: | 100 |

Generally, mixing is done under suitable agitation, except where high speed dispersal is indicated. For example, Soygreen 1000E Emulsion is a plasticizer which should be added slowly to the mixture, which provides improved coalescence and stabilization. In some embodiments, rheology modifying constituents are methyl ethyl hydroxyethyl cellulose e.g., (Bermocoll EHM Extra; AkzoNobel, Brewster, N.Y.), pentanoic acid, 5-(dimethylamino)-2-methyl-5-oxo-,methyl ester, and Rheotech® 2800. In some embodiments, as shown in the example composition, an additional polyurethane associative thickener is used, selected from those which are compatible with water-based coatings systems, which in some embodiments is a water-soluble polymer. Additionally, methyl ethyl hydroxyethyl cellulose is used in some embodiments, constituting a suitable, water-soluble cellulose derivative with hydrophobic functionality that promotes stability and flow, suitable to be used with present embodiments at or below about 0.1% by weight. Such rheology additives as those contemplated herein provide improved orientation of pigments in the compositions to enhance flow and brushability of the coating.

A favorable rheology additive for use with present coatings embodiments offers anti-sagging and anti-settling properties for aqueous pigment concentrates used in an exemplary formulation. Such a rheology additive exists in solution as a modified urea rheology additive with amide ester functionality. Such a rheology additive generates a three-dimensional network structure that prevents or limits sedimentation of particles and syneresis of the liquid base, while increasing anti-sagging properties of the overall coating without impairing the positive flow and leveling effects brought about by other constituents. The polar nature of sub-groups found in such a rheology additive facilitates thixotropic flow behavior to demonstrate favorable sheer thinning effects. Such a rheology additive includes, by way of example and without limitation, BYK-7420 ES (BYK®-Chemie GmbH).

RHEOTECH® 2800 (Coatex Arkema Group, Chester, S.C.) works with the other rheology modifiers described here to provide additional balance between high, medium and low shear rates. Additionally, in some embodiments, a polyurethane associative thickener as mentioned above is used, in that this non-ionic urethane rheology modifier provides increased low shear viscosity and works in combination with other rheology to attain a more balanced ratio of low shear to high shear viscosity. Four different rheology modifiers are provided for this example composition. It is not necessary that all four should be used in accordance with the scope of applicable claims, and other rheology modifiers may be added, substituted for these.

Although the example composition is referred to with actual weight percentages, the amount of the constituents can vary. For example, regarding the modifying constituents, a suitable weight percentage of methyl ethyl hydroxyethyl cellulose is in a range of about 0.1-1.0%. A suitable weight percentage for BYK®-7420 ES is in a range of about 0.2-0.5%. A suitable weight percentage for Rheotech® 2800 is in a range of about 0.5-1.0%. A suitable weight percentage for the polyurethane associative thickener, e.g., Tafigel® PUR 85, is in a range of about 0.2-1.0%.

For the resin content, a suitable weight percentage for Alberdingk® AC 2300 is in a range of about 20-25%. A suitable weight percentage for Alberdingk® AC 2320 is in a range of about 15-20%. A suitable weight percentage for EPS® 2574 acrylic emulsion is in a range of about 6-10%. A suitable weight percentage for Aquaslip® 656 is in a range of about 2-3%.

For the pigments which are mentioned above, a suitable weight percentage for a first Gold Mica Pearl pigment is in a range of about 8.5-9.5%. A suitable weight percentage for a second Gold Mica Pearl pigment is in a range of about 1.5-2.0%. A suitable weight percentage for a third Gold Mica Pearl pigment is in a range of about 1.2-1.5%. Fewer than a more than three such Mica pigments can be used. In some embodiments, an appropriate weight percentage of pigment is between about 11%-14.5%. In the example composition provided herein, the weight percentage of Mica pigment is 12.04%. Also, different levels of coarseness and fineness can be selected as desired by practitioners. In the example composition provided herein, a first Gold Mica Pearl pigment comprises particles sizes of up to 100 μm, while second and third Gold Mica Pearl pigment are both of particles sizes of up to 60 μm.

For other constituents, weight percentage can be modified as desired by a user depending on the particular circumstances, uses, and surface. Preferably, as adjustments to any one or more constituents are made within these suitable ranges, the content of other constituents is modified proportionally so the composition percentage comes to 100%. Various organic solvents, such as glycol ethers, are identified in the example composition. These and many other constituents possess properties and features which are well understood and whose inclusion in compositions of this sort is fairly convention.

In addition to the resins and the rheology combinations, various additives are advantageous because they offer improved anti-sedimentation, and have extremely good wetting and dispersing properties. Such an additive holds the pigment particles, e.g., Mica, in suspension longer which enables them to be in a more uniform alignment as the coating dries. Such an additive is a dispersant that promotes the pearlescent pigments to stay suspended in solution for longer periods.

With the favorable suspension quality, the solvent blend in the formulation, combined with the rheology modifiers, allows easy workability and brushability, and more substantially uniform alignment. Such a dispersant works as an associative acrylic thickener for the coating and facilitates Newtonian flow behavior of the system, with excellent flow and leveling, which in combination with enhances brushability of the coating. Such a dispersant is a High Molar Volume Polymeric dispersant that contains resin-compatible chains which protrude significant distances into the surrounding resin solution following adsorption of the dispersant onto the pigment surface. The chains comprise members that help maintain the separation of particles to limit re-flocculation by exhibiting a weakly cationic charge (i.e., capable of serving as a conjugate acid of a weak base) that works in combination with a self-crosslinking acrylic dispersion to aid in keeping pigment particles separate to avoid or limit re-flocculation. Such a dispersant includes, by example only and without limitation, an alkyl polyglycol ether phosphate ester.

Another additive utilized by the present embodiments is one that contains surface active features. Such an additive is an anionic surface active agent with pigment affinic groups that provide a strong, durable adsorption onto the pigment surface and creates a steric uniform balanced spatial alignment of the pigment particles. The electrostatic stabilization achieved by the anionic affinity brings steric stabilization to the system, which also serves to attract micro-pigment particles in the direction of the substrate. Such attraction makes for a smoother surface of the film and helps to minimize the tendency toward flocculation during film formation in use. Moreover, such an additive is a wetting and dispersing additive that works in combination with the self-crosslinking resin by absorbing onto pigment particles, surrounding the particles which allows them to attach to the resin structure. By attraction to the resin backbone, the pigment particles are less likely to agglomerate or undergo re-flocculation. Such an additive includes, by example only and without limitation, Pat-Add DA 603. (Patcham USA, LLC and/or Patcham FZC, UAE). Both Pat-Add DA 603 and alkyl polyglycol ether phosphate ester (e.g., PAT-ADD DA 817; Patcham) work together to serve similar but different purposes in the coating. Both are dispersants and both have steric or electrostatic influences on the pigment particles. But whereas alkyl polyglycol ether phosphate ester, and polyglycol ether phosphate esters generally as may be used alternatively, maintain suspension for improved appearance on drying, Pat-Add DA 603, and other additives of its kind, act more in terms of spatial alignment to control the association of pigment particles with one another and limit agglomeration that robs a coating of its reflectiveness. As a result, gloss testing at either 60 degrees (direct reflection) or 20 degrees (sharpness) is improved, producing less cloudiness and haziness in the appearance from different visual angles. A suitable weight content for alkyl polyglycol ether phosphate ester is about 1.0%-1.5%. A suitable weight content for Pat-Add DA 603 is about 0.8%-1.3%.

Other constituents, suitable for compositions according to the embodiments provided, include ACRYSOL™ ASE-60 (Rohm and Haas), a thickener that helps reduce excessive flow. Soluble at the alkaline pH's suitable for these embodiments, this constituent improves the low-shear rate viscosity and helps increase the shear thinning characteristics of the product. Wetting agents such oxirane, methyl-,mono(3,5,5-trimethylhexyl ether) in combination with ethoxylated alcohol non-ionic surfactants as METOLAT® 750 and METOLAT® 780 (MUNZING, Bloomfield, N.J.) provide leveling and dispersion to the overall compositions. Defoamers such as those which are known and commonly used in the art are also employed according to multiple embodiments herein, and may comprise about 0.3%-1.3% by weight of the composition. In some embodiments, as shown in the example composition, the defoamers are BYK® 024 (0.18%), BYK® 022 (0.18%), and Agitan® 786 (0.10%, Munzing Chemie GmbH), all of which are commercially available.

Other additives include a 30% Dow Corning® 51 Additive, an ultra-high-molecular-weight polydimethylsiloxane dispersion with 100% solids (e.g., suitable ranges of about 0.5-1.0%). The procedure entails diluting to 30% in water and diethylene glycol monobutyl ether (e.g., suitable ranges of about 2.5-3.5%). It will be appreciated that all the other constituents, which are listed in the example composition, are known. It is possible for various substitutes to be used for other constituents, in accordance with the scope of broad embodiments. Although all constituents are known and commercially available, the performance of the compositions as a whole necessarily depends on the selection of other constituents, their compatibility, the correct blending amounts and procedures, and the capacity of each constituent to enhance (without masking) the favorable attributes of the other constituents. Present embodiments provide beneficial and non-obvious results whereby the act of brushing does not disturb the necessary alignment of the metallic pigment particles, owing largely to performance of the resin system in view of rheology modifications.

Although an exemplary coating composition is provided, in view of multiple embodiments and alternatives available from the present disclosure, this is not intended to limit the scope of claimed embodiments, but rather to help illustrate the disclosures herein. Other constituents having similar properties to those disclosed herein are within the scope of present embodiments. The ranges may be modified within reason. The scope of embodiment is not limited to the exact percentages mentioned in the example.

It is to be understood that the embodiments described and/or claimed herein are not limited in their application to the details of the teachings and descriptions set forth herein, or as illustrated in an example. Rather, it will be understood that the embodiments are capable of being practiced or carried out in multiple ways, according to many alternatives based on these descriptions and teachings.

Further, it will be understood that the phraseology and terminology used herein is for the purpose of description and should not be regarded as limiting. The use herein of “including,” “comprising,” “e.g.,” “such as, for example,” “containing,” or “having” and variations of those words is meant in a non-limiting way to encompass the items listed thereafter, and equivalents of those, as well as additional items. Accordingly, the foregoing descriptions are meant to illustrate a number of embodiments and alternatives, rather than limiting to the precise forms and processes disclosed herein. The descriptions herein are not intended to be exhaustive. It will be understood by those having ordinary skill in the art that modifications and variations of these embodiments are reasonably possible in light of the above teachings and descriptions.

What is claimed is:

1. A pigment-containing, multi-constituent, resin-based curable coating composition comprising:
a plurality of resins, at least one of which is a self-crosslinking acrylic resin;
a wax emulsion;
a rheology additive that generates a three-dimensional network structure comprising polar sub-groups; and
a dispersant comprising cationic side chains for maintaining separation of particles to limit re-flocculation,
wherein the pigment comprises metallic pigment particles.

2. The composition of claim 1, further comprising an anionic surface active compound additive providing electrostatic stabilization and steric stabilization to the system for attracting micro-pigment particles in the direction of the surface.

3. The composition of claim 1, wherein the dispersant is an associative acrylic thickener that promotes pigment particles to stay in suspension.

4. A method of forming a coating composition comprising mixing:
one or more metallic pigment particles with a plurality of resins, wherein at least one of such plurality of resins is a self-crosslinking acrylic resin,
a rheology additive that generates a three-dimensional network structure comprising polar sub-groups,
a dispersant comprising cationic side chains for maintaining separation of particles to limit re-flocculation, and
an anionic surface active compound additive providing electrostatic stabilization and steric stabilization to the system for attracting micro-pigment particles in the direction of the surface,
wherein when the composition is mixed, applied on a substrate and allowed to dry, the metallic pigment particles are in substantially uniform alignment.

5. The method of claim 4, wherein the dispersant is an associative acrylic thickener that promotes pigment particles to stay in suspension.

6. A method of coating a substrate, comprising: applying to a surface of the substrate at least a first layer of a coating composition comprising metallic pigment particles; a plurality of resins, at least one of which is a self-crosslinking acrylic resin; a wax emulsion; a rheology additive that generates a three-dimensional network structure comprising polar sub-groups; a dispersant comprising cationic side chains for maintaining separation of particles to limit re-flocculation; and an anionic surface active compound additive providing electrostatic stabilization and steric stabilization to the system for attracting micro-pigment particles in the direction of the surface.

7. The method of claim 6, wherein the dispersant is an associative acrylic thickener that promotes pigment particles to stay in suspension.

8. The method of claim 6, further comprising applying a second layer of said coating composition, wherein after said first and second layers are applied and allowed to dry, the metallic pigment particles have intra-layer and interlayer alignment.
